(19) United States
(12) Patent Application Publication
(10) Pub. No.: US 2011/0197704 A1
(43) Pub. Date: Aug. 18, 2011

(54) YOKE FOR PEDAL ASSEMBLY WITH SCRAPER RING

(75) Inventor: Arnaud Sitbon, Bucuresti (RO)

(73) Assignee: RENAULT S.A.S., BOULOGNE-BILLANCOURT (FR)

(21) Appl. No.: 13/057,344

(22) PCT Filed: Jul. 24, 2009
(86) PCT No.: PCT/FR09/51493

§ 371 Date: Apr. 25, 2011

(30) Foreign Application Priority Data
Aug. 4, 2008 (FR) 0804421

(51) Int. Cl. G05G 1/30

(52) U.S. Cl. 74/594.4

(57) ABSTRACT

A pedal assembly yoke connected to a vehicle bulkhead, the yoke carrying a shaft on which are mounted at least one pedal and at least one ring, the ring located so as to be adjacent to a universal joint of a steering column of the vehicle. A vehicle can include such a yoke.

The invention relates to a pedal-assembly yoke. More particularly, the invention relates to a pedal-assembly yoke for a motor vehicle. Even more particularly, the invention relates to a pedal-assembly yoke with a sliding bush.

At present, a pedal-assembly yoke of a motor vehicle has a shaft supporting at least one pedal that can pivot around it. During a violent impact at the front of the vehicle, for example in the case of an accident, the front of the vehicle tends to advance, entraining the bulkhead and the pedal-assembly yoke fixed thereto toward the passenger compartment. The shaft of the pedal-assembly yoke then hooks into the universal joint of the steering column, causing this to advance toward the driver, then constituting a danger for him.

The invention consists in creating a pedal-assembly yoke of a motor vehicle that does not represent a danger for the driver in the case of impact at the front of the vehicle.

According to a first aspect of the invention, the pedal-assembly yoke is made integral with a bulkhead of the vehicle, the said yoke supporting a shaft on which there are mounted at least one pedal and at least one bush situated in such a way as to face the universal joint of the steering column of the said vehicle. The bush is intended to make the pedal-assembly yoke slide over the universal joint of the steering column in the case in which the bulkhead would advance into the passenger compartment under the effect of a violent shock caused at the front of the vehicle.

In particular, the bush is translationally held on the shaft by at least one means for retaining the said bush. The retaining means may be a bush mounted clamped on the shaft or else a pin or else a clip engaging in a groove made in the thickness of the shaft. The person skilled in the art will be able to envision any known device for preventing translation of the bush.

Again according to the invention, the pedal-assembly yoke supports a shaft on which there are mounted at least a brake pedal and a clutch pedal. The invention is adapted to any type of mounting having a shaft facing a universal joint, and for which it would be desired to prevent the shaft from coming into contact with the universal joint in the case of movement of one of these two parts toward the other.

Advantageously, the bush is situated between the two pedals.

In particular, the bush is translationally held on the shaft by a pedal on one side and by the yoke or by another pedal on the other side.

Advantageously, the bush and at least one adjacent pedal, for example the clutch pedal, are mounted on a sleeve surrounding the shaft. The shaft sleeve carrying the pedal and the bush make it easier to mount these on the pedal-assembly yoke.

Ideally, the bush is of a rigid material in order to permit the entire pedal-assembly yoke to slide over the universal joint. Advantageously, the bush is of plastic, making it possible to obtain a rigid and lightweight bush at less cost. Quite obviously the person skilled in the art would be able to envision making it of any other material having substantially the same rigidity characteristic, such as metal.

The invention also relates to a vehicle comprising a yoke such as described in the foregoing.

The invention now is described with reference to the drawings, which are non-limitative and in which:

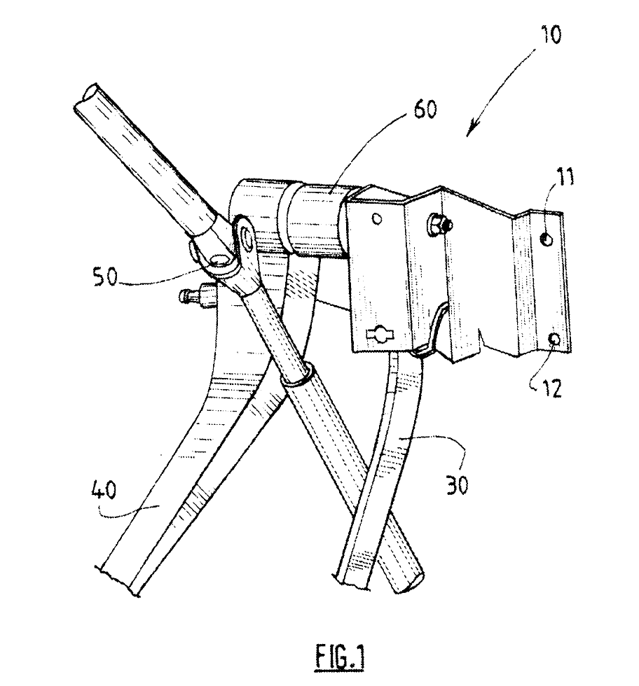

FIG. 1 is a general view of a pedal-assembly yoke according to the present invention;

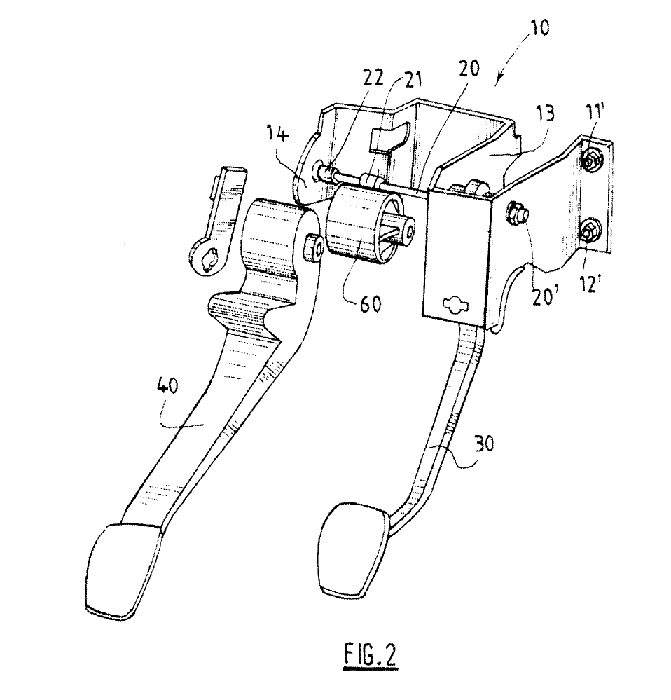

FIG. 2 is a semi-exploded general view of the pedal-assembly yoke shown in FIG. 1.

According to the embodiment shown in FIGS. 1 and 2, a pedal-assembly yoke 10 is made integral on a vehicle bulkhead (not shown). In our example, the yoke is made integral by way of three orifices, of which two, 11 and 12, are visible in FIG. 1, positioned on threaded pins welded to the vehicle bulkhead. The whole is retained by three nuts, of which two, 11′ and 12′, are visible in FIG. 2. Pedal-assembly yoke 10 supports a shaft 20, on which there are mounted a brake pedal 30, a clutch pedal 40 and a bush 60. Bush 60 is situated facing universal joint 50 of the steering column of the vehicle. Shaft 20 is retained in position by a screwed nut 20′ on one side, the other being retained by a screwed nut or being retained by another means envisioned by the person skilled in the art.

By virtue of the position of bush 60 facing universal joint 50 of the steering column, at the time of a shock such as a frontal collision at the front end of the vehicle, resulting in causing the bulkhead to move back toward the passenger compartment, entraining pedal-assembly yoke 10 which then approaches universal joint 50, bush 60 causing the yoke to slide downward or upward over the said universal joint 50, then preventing the steering column from advancing toward the driver.

In the illustrated example, bush 60 is held on one side by inside cheek 13 of the pedal-assembly yoke and on the other side by retaining bush 21 clamped on shaft 20. Clutch pedal 40 is then retained between retaining bush 21 and another retaining bush 22 contiguous with an outside cheek 14 of pedal-assembly yoke 10.

According to a particular mode of assembly, a retaining bush 22 is made integral on a sleeve, not shown, having a length similar to the spacing between outside cheek 14 and inside cheek 13, by clamping, welding or adhesive bonding. Clutch pedal 40 is then positioned, followed by another retaining bush 21, made integral by the same principle as for bush 22. Finally, bush 60 is positioned on the said sleeve.

Shaft 20 is then installed through the orifice made for this purpose in outside cheek 14, then into the pre-assembled sleeve, then into the orifice made in cheek 13, then into brake pedal 30 and finally into the orifice made for this purpose in outside cheek 15.

Thereafter the nuts are screwed on at each end of shaft 20 in order to hold it translationally.

Subsequently, pedal-assembly yoke 10 is made integral on the vehicle bulkhead, then pedals 30, 40 are connected to their respective control devices, not shown.

In our example, the external section of bush 60 is cylindrical, but the person skilled in the art would be able to envision a different section that makes it possible to have bush 60 and therefore the pedal-assembly yoke slide over universal joint 50 of the steering column.

1-9. (canceled)

10. A pedal-assembly yoke made integral with a vehicle bulkhead, the yoke supporting a shaft on which there are mounted at least one pedal and at least one bush situated so as to face a universal joint of a steering column of the vehicle.

11. A pedal-assembly yoke according to claim 10, wherein the bush is translationally held on the shaft by at least one means for retaining the bush.

12. A pedal-assembly yoke according to claim 10, supporting a shaft on which there are mounted at least a brake pedal and a clutch pedal.

13. A pedal-assembly yoke according to claim 12, wherein the bush is situated between the brake pedal and the clutch pedal.

14. A pedal-assembly yoke according to claim 10, wherein the bush is translationally held on the shaft by a pedal on a first side and by the yoke or by another pedal on another side.

15. A pedal-assembly yoke according to claim 14, wherein the bush and at least one adjacent pedal are mounted on a sleeve surrounding the shaft.

16. A pedal-assembly yoke according to claim 10, wherein the bush is of a rigid material.

17. A pedal-assembly yoke according to claim 10, wherein the bush is of plastic.

18. A vehicle comprising a yoke according to claim 10.
